(19) United States
(12) Patent Application Publication
(10) Pub. No.: US 2011/0149363 A1
(43) Pub. Date: Jun. 23, 2011

(54) Lidar Mean Power Reduction

(75) Inventors: Michael Harris, Hollybush (GB); Steven Michael Stone, Malvern (GB); Andrew Lewin, Malvern (GB)

(73) Assignee: QINETIQ LIMITED, London (UK)

(21) Appl. No.: 13/059,559

(22) PCT Filed: Aug. 12, 2009
(86) PCT No.: PCT/GB09/01975

§ 371 Date: Feb. 17, 2011

(30) Foreign Application Priority Data
Aug. 18, 2008 (GB) 0815066.6

(51) Int. Cl. G02B 26/00; H01S 3/13; G02F 1/29

(52) U.S. Cl. 359/238; 372/29.012; 359/298

(57) ABSTRACT

A laser radar device adapted to ensure that the output from the laser is eye-safe. A means for applying spatial dither to the output of the laser source, such as a moveable optical arrangement. This causes the point of focus of the transmitted beam to traverse a target area by small amounts, reducing the overall radiation exposure at any particular point of focus, but having negligible impact on wind speed measurement for example. Alternative arrangements for ensuring eye-safety include periodically reducing the laser power density, gating the output or altering the focussing of the transmitted beam.

This invention relates to coherent laser radar (CLR) or lidar (laser radar) apparatus, especially as used for wind speed measurement, and to techniques for ensuring the laser output from the apparatus is eye-safe, i.e. would not cause any damage to the eyes of any person irradiated by the lidar apparatus.

It is well known that lidar devices can be used for various remote measurements, from ranging and vibrometry to flow analysis of fluids. Lidar has also been known for measurement of wind speed in a variety of meteorological and aerospace applications. For wind speed measurement the technique relies on receiving light backscattered from natural aerosols in the atmosphere and the inherently weak nature of such signals necessitates the emission of relatively high laser power from the lidar transmitter. Focussing of the output beam will also increase the power density of the radiation at the point of focus.

Issues of eye safety for use of lasers involve consideration of the wavelength of operation of the laser, the power density that can be experienced and also the duration. Acceptable emission limits are derived by considering all these items and laser classification is based on such limits. The current European standard for laser safety classification, EN 60825-1:2007, uses Acceptable Emission Limits derived from Maximum Permissible Exposure (MPE) levels. The MPE levels represent the maximum level to which the eye can be exposed without consequential injury immediately or after a long time and are related to the wavelength of the laser radiation, the pulse duration or exposure duration, the tissue at risk and, for visible and near infra-red laser radiation in the range 400 nm to 1400 nm, the size of the retinal image.

Clearly safety issues are very important and where a laser apparatus has an output that could cause eye damage the safety requirements are increased as compared to a laser product which is eye-safe. These requirements include not only additional product features such as warning devices etc. but also increased training of personnel and guidelines relating to usage of the apparatus.

Therefore ensuring that a lidar device is eye-safe can reduce the overheads associated with training, laser safety risk assessment and the like and allow such lidars to be deployed easily and safely in a wide range of environments as compared to use of a higher classification of laser product. Thus it is an object of the present invention to provide a lidar device with improved eye safety.

Thus according to the present invention there is provided a laser radar device comprising a laser source and output optics further comprising a mean power reducing means. The mean power reducing means or arrangement acts to reduce the power density of the output beam and/or duration of irradiance that could be experienced at a point in space. Reducing the power density and/or duration of the radiation exposure generally reduces the risk of eye damage and thus increases the eye safety classification of the laser radar device.

The mean power reducing means may be arranged to periodically reduce the laser power density of the output beam of radiation. A coherent laser radar device can typically make a measurement of line-of-sight (axial) wind speed on a timescale of a few milliseconds. For applications where rapid update rates, for instance more than a few updates a second, are not required the laser output power density can be reduced when not making a measurement so as to reduce the overall exposure at any point in space. In other words the lidar operates with maximum power density only for as long as required to make an individual measurement. This is applicable to both continuous wave (CW) and pulsed laser sources—unless the pulse rate and pulse duration of the laser source is already just sufficient for measurement purposes.

The mean power reducing means may periodically reduce the power density of the output beam by intensity modulating the beam produced by the laser source. Conveniently the intensity modulation of the laser source may modulate the output intensity to zero, in other words the mean power reducing means prevents emission of an output beam of radiation outside the measurement periods. Reducing the intensity of output radiation, or even completely stopping any radiation, outside the measurement periods can reduce the radiation power experienced at any point in space over time which can have benefits for eye safety.

The mean power reducing means may intensity modulate the laser output beam by direct control of the laser, for instance by controlling the laser power so as to, in effect, switch off the laser source for a limited period of time between measurement periods. The mean power reducing means may therefore comprise a laser control unit. Such an arrangement is simple to implement but continual switching of the laser source on and off may have an adverse effect on the lifetime of the source.

As an alternative the mean power reducing means may comprise an intensity modulator acting on the output of the laser source. The intensity modulator may be any suitable means or device for intensity modulating the radiation produced by the output source. For instance the intensity modulator means comprise a mechanical shutter moveable to block or partially block the output beam of radiation. A moveable mirror or other reflective means could be arranged in the optical path so as to control the amount of radiation directed to the output of the device. One or more filters may be arranged that could be inserted into the optical path from the source the device output or controlled so as to alter the amount of radiation transmitted by the device. Where the device comprises fibre optic cable in at least part of the output path the intensity modulator may comprise a means of moving the fibre optic cable relative to some output optics.

Additionally or alternative to intensity modulating the laser beam, the mean power control means may alter the focussing of the transmitted beam. As mentioned above when making a measurement the transmitted beam may be well focussed to the measurement probe volume, i.e. the region of space from which measurements are being taken. Again where there is not a need for rapid updating the mean power control means may be arranged to effectively defocus the transmitted beam when not making a measurement. Defocusing the transmitted beam in effect spreads the power across a wider area and hence reduces the maximum power density that could be experienced at a point in space. Generally a laser radar device will comprise optical elements for directing and focussing the transmit beam to the measurement probe volume. The mean power reducing means may therefore comprise one or more actuators for altering the arrangement of the one or more optical elements to defocus the transmitted beam. In many laser radar devices the one or more optical elements are designed to be configurable to provide different levels of focus for the purpose of acquiring measurements from different ranges and hence the actuators for configuring the one or more optical elements may be arranged to provide both the focussing at different ranges for measurement and defocusing between measurements. It will be noted that this embodiment of the present invention is different to known laser radar devices in that it is arranged to produce a transmitted beam which is defocused as to reduce the maximum power density that can be experienced.

The mean power reducing means could additionally or alternatively comprise a power reducing optical element which can be introduced, repositioned or reconfigured within the optical path from the laser source to the device output aperture so as to defocus the transmitted beam. For instance the power reducing means may comprise a lens and a means of introducing said lens into the optical path.

In some applications however the required measurement rate, i.e. the rate at which measurements are acquired, of the lidar may be high and reducing the power density between measurements may not be practical. Further, in some applications even though it may be possible to reduce the power density between measurements, so as to reduce the overall exposure, the power and duration used during a measurement may not be eye-safe and clearly such a lidar would be classified as non eye-safe.

In a preferred embodiment therefore the means power reducing mean comprises a means of applying a spatial dither to the transmitted beam so as to move the point of focus. The term spatial dither is well known in imaging and refers to moving a detector relative to an image by a small amount, usually to increase signal to noise or provide sub-pixel resolution. As used herein the term spatial dither means movement of the point of focus of the transmitted beam by small amounts that causes the point of focus of the beam to traverse an area in space greater than the beam cross section area.

Moving the point of focus of the transmitted beam has a very small effect on the measurement results, especially for wind speed measurement lidars. Such lidars may typically have operating ranges from a few metres of tens of metres out to hundreds of metres. For instance a wind speed measurement lidars may operate at ranges of 50 metres or more and may operate up to 500 m or more and at such ranges a small spatial dither does not significantly effect the measurement. In effect the laser radar device is taking measurements from a slightly larger probe volume and from directions that differ slightly, but this has a negligible effect on the wind speed measurement. However the transmitted beam is not focussed on exactly the same point for the whole duration of the measurement and is moved from one point of focus to a different point of focus having no overlap with the first point of focus. Thus the overall radiation exposure at any particular point of focus is reduced.

As mentioned above the spatial dither which is applied should be sufficient that the point of focus is moved by an amount greater than the beam cross section. The maximum spatial dither applied, i.e. the maximum spatial movement of the point of focus due to the applied dither, is therefore at least equal to the beam diameter at the point of focus However a small amount of spatial movement is preferred so that the measurement probe volume is relatively small. Thus the amount of spatial dither applied may be of the order of 20 times the beam diameter at the point of focus or less, or of the order of 10 times the beam diameter at the point of focus or less or 5 times the beam diameter at the point of focus or less. At a range of 100 m a small amount of dither, say of the order 0.5° would lead to a movement of the point of focus by about 1 m.

Where the spatial dither is applied by varying the angle at which the laser beam is transmitted the angle may be dithered by a few degrees or less. A small variation in the angle at which the laser beam is transmitted vary the angle between the wind vector (i.e. the actual direction of the wind) and the transmitted beam. This will lead to a small modulation of the line of sight wind speed as measured by the lidar but at small angular variations this modulation will be negligible.

The spatial dither may be applied continuously, i.e. the point of focus of the transmitted beam is moved continually and the locus of movement includes at least two positions that have no area of overlap. Alternatively the dither could be applied periodically, i.e. the point of focus is located in a first position for a first short period and then is dithered to a second position for a second short period with there being at least two positions that do not overlap. In either case the spatial dither is preferably applied on a timescale such that the point of focus is dithered at least once in each measurement time. Arranging at least one dither cycle in each measurement time helps eliminate bias being introduced into the measurement. The extent and duration of the dither cycle is however chosen that any one point of space, i.e. each point which is illuminated during the cycle (or repeat cycles) receives a total exposure to radiation which is within eye-safe limits.

As mentioned above the effect of the spatial dither is to effectively move the point of focus around a measurement probe volume that is slightly larger than it would have been with no dither. It should be noted however that the instantaneous power at the current point of focus is not altered. Thus the necessary power for good signal returns is still transmitted. Also the total measurement time is also maintained. However the radiation is no longer concentrated on a single point in space and hence the mean power experienced at that point in space is reduced, with consequential benefits for eye safety.

The means for applying spatial dither may apply an angular shift to the transmitted beam or a translation shift or both. The means for applying spatial dither may comprise a moveable optical element which may be reflective or transmissive. For example the means for applying spatial dither could comprise a rotatable transmissive element such as a wedge shaped element arranged in the optical path and which changes the angle of transmission slightly depending upon its position. A rotatable wedge shaped transmissive element may be rotated continually to provide continuous dither in the form of a small angle conical scan. As another example the means for applying spatial dither could comprise a moveable mirror arranged in the optical path to direct the transmitted beam. The mirror could be moveable to a number of fixed positions and moved periodically to provide periodic spatial dither or again the mirror may for instance be arranged to rotate to provide small scanning angles. As another alternative, when at least part of the optical path involves fibre optic cable, the means for applying spatial dither may comprise means for moving the fibre optic cable relative to some transmit optical elements.

It should be noted that it is known to provide relatively large scale scanning of laser radar devices. Laser radar devices having scanning mirrors and the like are known. However conventional scanner laser radar devices are distinguished from the present invention that provide spatial dither of the transmitted beam. Conventional scanned laser radar systems have relatively large and relatively slow scan patterns compared to measurement probe volume and time taken to acquire a measurement. The purpose of conventional scanning is to allow the device to acquire readings from distinct measurement probe volumes. This requires that the scan provides a relatively large degree of movement of the measurement probe volume so that different areas of the volume under investigation can be measured. However the transmit beams should be located in a small measurement probe volume for long enough for a good measurement to be obtained. Thus conventional scanned laser radars have a scan cycle with a large degree of motion of the point of beam focus—which may be of the order of tens or hundreds of times the beam diameter—but with a cycle repeat time which may be tens or hundreds of times as long as a measurement duration. This embodiment of the present invention relies on applying spatial dither which moves the point of focus of the beam on a very small scale and does so in a time scale faster than the measurement duration for the purpose of reducing power density at particular locations in space in order to comply with laser eye safety requirements rather than for the purpose of conducting a spatial survey.

The spatial dither embodiment of the invention could be implemented in a scanning laser radar where the motion of the beam focus due to the scanning alone would lead to eye safety issues. This could easily be achieved by having a means of applying spatial dither arranged in the optical path from the source to the device output prior to a scanning arrangement.

This embodiment of the present invention is particularly applicable to staring laser radar device, i.e. devices which have a fixed look direction, or stepped staring laser radar devices, i.e. devices which cycle between a plurality of different look directions but which have a relatively long dwell time at each look direction.

This embodiment of the present invention is also particularly applicable to laser radar devices in which fibre optics are used to guide radiation output from the source. Fibre optics provide a convenient way of guiding laser radiation from the source to any transmit optics of a laser radar device and have been increasingly used in laser radar devices. However there is a limit to the intensity of radiation that can be guided within fibre optics without the guided light interacting with the fibre optic and experiencing non-linear effects which negatively impact on device operation. Thus there is a maximum intensity that can be transmitted from a fibre based laser radar for satisfactory operation. In some applications this limit to the power that can be transmitted requires a much longer duration of exposure for a measurement to achieve a satisfactory signal to noise ratio. Thus fibre based laser radars may not be able to achieve the same power output as a non fibre based lidar. Noise reduction is proportional to the square root of the time of measurement and thus if the fibre lidar can achieve only half the power of a non-fibre lidar the measurement duration would need to be four times longer for the fibre based lidar to achieve the same signal to noise ratio. Thus the overall potential radiation exposure may be greater from the fibre based lidar. The laser radar device of the present invention may comprise fibre optic cable for guiding radiation from the source to the device output.

The invention therefore also provides, in another aspect, a laser radar device comprising a laser source and a means of applying spatial dither to the output of the laser source. The laser radar device may comprise a staring laser radar device or a laser radar device which cycles between a plurality of different stare directions.

In another aspect of the present invention there is provided a method of operating a laser radar device comprising the steps of generating a beam of radiation from a laser source and applying spatial dither to the beam as transmitted from the device so as to move the point of focus. As for the first aspect of the invention the spatial dither applied moves the point of focus of the transmitted beam by small amounts so that the point of focus of the beam traverses an area in space greater than the beam cross section area. As described above the maximum amount of spatial dither applied may be less than 20 times the beam diameter at the point of focus, or less than 10 times the beam diameter at the point of focus or less than 5 times the beam diameter at the point of focus. The spatial dither may be applied continuously or periodically. All the advantages and embodiments of applying spatial dither as described above apply equally to the method of the present invention.

The invention will now be described by way of example only with reference to the following drawings of which:

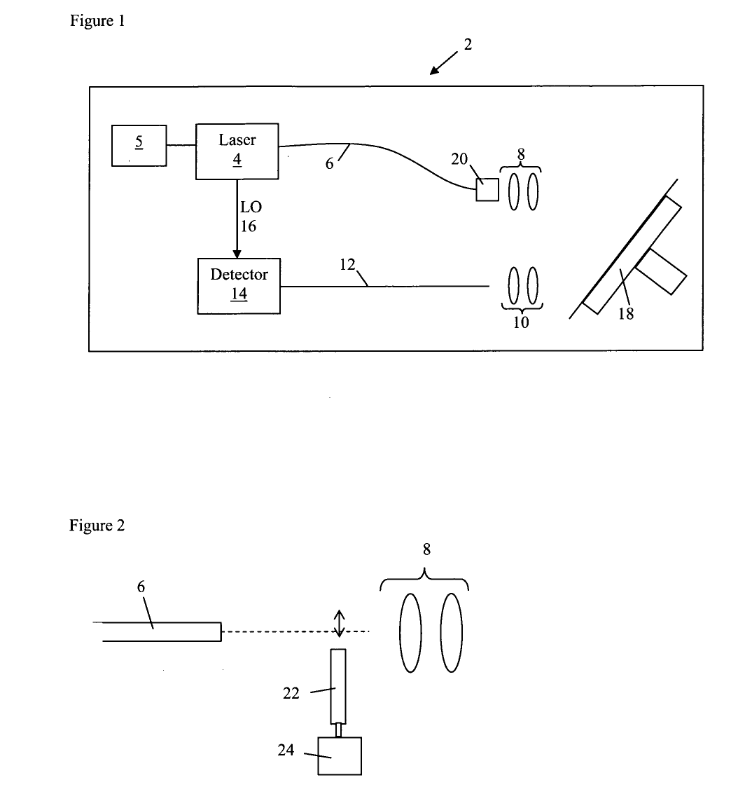

FIG. 1 shows a schematic of a laser radar device having a power reducing means according to the present invention,

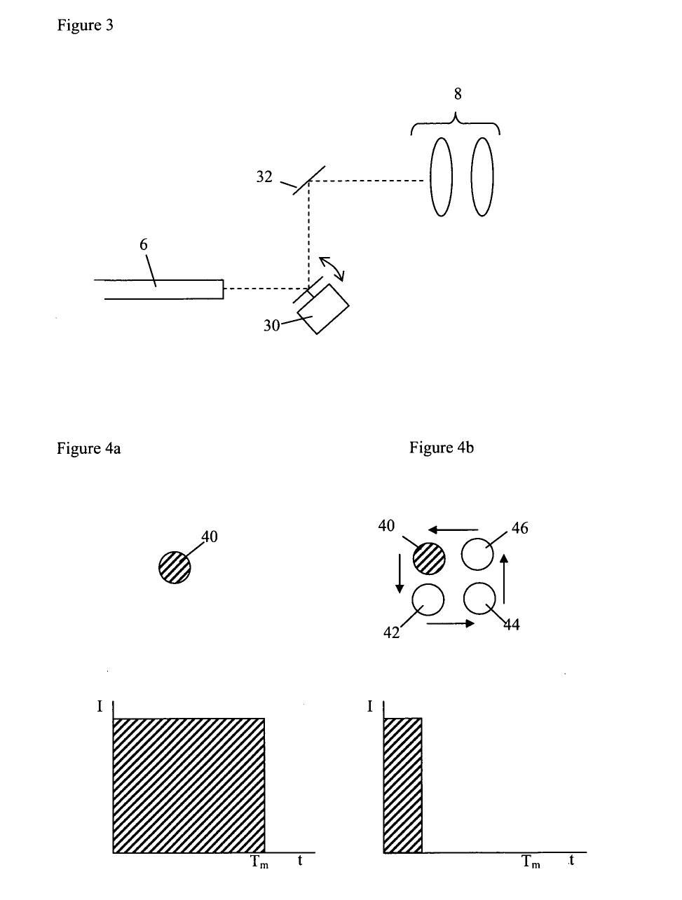

FIG. 2 illustrates a power reducing means comprising a moveable element which can inserted into the optical path,

FIG. 3 shows a moveable mirror power reducing means,

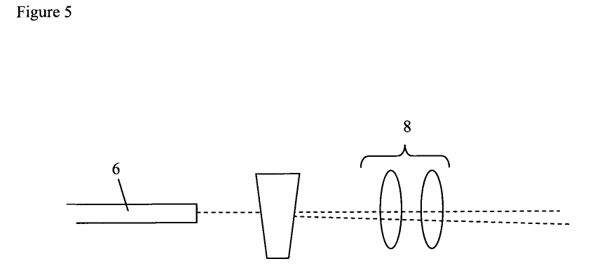

FIG. 4 illustrates the effects of spatial dither, and

FIG. 5 shows a rotatable element in the optical path for providing spatial dither.

FIG. 1 illustrates a basic laser radar device, generally indicated 2, arranged for wind speed measurement. A laser source 4 controlled by control unit 5 outputs radiation into fibre optic cable 6. The laser source 4 may be a pulsed laser or a continuous wave laser. The fibre optic 6 guides the laser light to transmit optics 8. Transmit optics 8, which may for instance comprise a telescope arrangement projects and focuses light to a measurement probe volume in the scene. Radiation backscattered from aerosols in the measurement probe volume is collected by receive optics 10—which are focussed to the same probe volume—and coupled to fibre optic cable 12 which guides the received light to detector 14. A local oscillator signal is also derived from the laser source 4 and passed via fibre optic cable 16 to detector 14. Any movement of the aerosols in the probe volume due to wind will impart a Doppler shift to the backscattered radiation which is detected by heterodyne detection in the detector 14. This Doppler shift can then be translated by a processor (not shown) into a line of sight wind speed component.

The transmit optics 8 and receive optics 10 are moveable so as to provide focussing at different ranges. The apparatus may also comprise a scanning arrangement 18 such as a moveable mirror for changing the look direction of the apparatus. The scanning arrangement may provide continuous scanning, such as a conical scan, or may be stepped between certain pre-defined look directions so that a particular look direction is chosen and measurements performed at one or more ranges with no further scanning during the measurement time. After the measurements are completed the scanning apparatus may step to the next look direction.

FIG. 1 illustrates a bistatic lidar, i.e. an apparatus having separate transmit and receive optics, but the skilled person will be well aware of monostatic lidar systems which uses common optics for transmitting the output beam and receiving any backscattered radiation.

The laser radar device 2 further comprises a mean power reducing means 20 acting on the radiation produced by the laser. The power reducing means may conveniently be located between the transmit end of fibre 6 and the transmit optics 8.

In one embodiment, shown in FIG. 2, the power reducing means comprises a moveable element 22 that can be removably inserted into the optical path between the end of fibre 6 and transmit optics 8. The moveable element may be an opaque material which, when located outside of the optical path, has no effect on the intensity of transmitted radiation, but which when located wholly in the optical path stops any radiation from being emitted from the laser radar. Alternative the moveable element may be a filter which absorbs a substantial amount of radiation when located in the optical path. The moveable element can be fully retracted from the optical path when a measurement is being made and then inserted fully into the optical path between measurements so as to prevent the device from emitting except during measurements.

In another embodiment, shown in FIG. 3 the power reducing means comprises a moveable mirror element 30 located at the output of fibre 6 in relation to a fixed mirror 32. The moveable mirror is moveable from a first position, in which light emitted from the end of fibre 6 is reflected towards transmit optics 8 via fixed mirror 32, to a second position, in which light from the moveable mirror 30 is directed away from fixed mirror 32, conveniently to an absorbing material and thus no light is emitted from the lidar.

The embodiments described with reference to FIGS. 2 and 3 therefore allow radiation to be emitted from the lidar device only during measurement periods. This reduces the total amount of radiation emitted and thus can reduce the potential exposure to laser radiation. Another method of achieving this would be to control the laser directly. For instance, referring to FIG. 1 again, a separate power reducing means 20 could be omitted and instead power unit 5 could comprise the power reducing means and be arranged to switch the laser source 4 off between measurements.

An alternative to reducing the intensity of the beam between measurement periods is to defocus the beam between measurement periods. This has the effect of reducing the maximum power density of the transmitted beam. One way of achieving this could be to introduce or remove an optical element from the optical path. For instance. referring back to FIG. 2 the moveable element 22 could instead be a lens or other optical element having focussing power. With the moveable element 22 out of the optical path the transmit beam is well focussed by the transmit optics to the appropriate measurement probe volume. When element 22 is introduced the beam becomes defocused.

Defocusing could also be achieved by using the transmit optics themselves, without the need for an additional optical element 22. As mentioned above transmit optics 8 may be moveable for focussing the transmitted beam to different ranges. In an embodiment of the present invention the range of movement of the transmit optics may be adapted such that the transmit optics can be moved to a position such that the transmitted beam is not at all focused. Between measurements the transmit optics could be moved to the position where the beam is unfocused to reduce the power density within the measurement probe volume.

The embodiments described with reference to FIGS. 2 and 3 above reduce the intensity and/or power density of the beam during a dead time when no measurements are being made. In an alternative embodiment the lidar can be operated in a continuous manner but spatial dither is applied to the beam. Applying spatial dither to the transmitted beam moves the point of focus slightly in the scene. As long as the amount of spatial dither is small, say of the order of five times the beam diameter at the point of focus or so, then the returns can be effectively be taken to come from the same measurement volume and the angular effect on the measurements is negligible. FIG. 4 illustrates the effect of spatial dither. FIG. 4a illustrates a plane in space which is perpendicular to the transmitted beam and taken at the point of focus of the beam, i.e. the point at which the beam waist is most narrow and consequently the power density is highest. Area 40 represents the area illuminated by the beam without any spatial dither and the graph indicates the measured intensity against time in area 40 for the measurement period Tₘ. As the beam is simply maintained in the same place then the intensity is the same relatively high intensity (not accounting for varying atmospheric losses) for the whole measurement time.

FIG. 4b however illustrates the situation with spatial dither applied. At a first time the beam is focussed to the same area 40 as illustrated in FIG. 4a. However after a short time, say equal to a quarter of the measurement time, the beam is quickly dithered to a different position 42 (which has no overlap with area 40) where it stays for another quarter of the measurement time before being moved to positions 44 and 46 in turn. The graph of intensity against time measured for area 40 now has the same intensity measured for the first quarter of the measurement duration but then the intensity drops to zero. The average power over the whole of the measurement time is therefore reduced for area 40 by a factor of four. However at all times the instantaneous illuminating intensity at the area of current focus is maintained at the same level as without spatial dither. The small movement of the beam has negligible effect on the resultant wind speed readings but it has a significant impact on eye safety.

One way to achieve spatial dither is shown in FIG. 5. Here the power reducing means 20 comprises a refracting optical element, e.g. a transmissive element with a slight wedge shape, rotatably arranged in the optical path between the end of fibre 6 and transmit optics 8. Refraction of light passing through the wedge gives a slight inclination to the beam and rotation of the wedge changes the direction of the inclination and thus directs the point of focus to a slightly different position.

An alternative arrangement can use the same apparatus as shown in FIG. 3. In this embodiment however the moveable mirror 30 can adopt a number of different positions which reflect light to the transmit optics 8 via fixed reflector 32, with each different position having a different amount of spatial dither.

Other arrangements will be apparent to those skilled in the art within the spirit of the present invention.

1. A laser radar device comprising a laser source and a means of applying spatial dither to the output of the laser source.

2. A method of operating a laser radar device comprising the steps of generating a beam of radiation from a laser source and applying spatial dither to the beam as transmitted from the device so as to move the point of focus.

3. A method as claimed in claim 2 wherein the point of focus of the transmitted beam is moved such that the point of focus of the beam traverses an area in space greater than the beam cross section area.

4. A method as claimed in claim 2 wherein the maximum amount of spatial dither applied is less than 20 times the beam diameter at the point of focus, or less than 10 times the beam diameter at the point of focus or less than 5 times the beam diameter at the point of focus.

5. A laser radar device comprising a laser source and output optics further comprising a mean power reducing means.

6. A laser radar device as claimed in claim 5 wherein the mean power reducing means is arranged to periodically reduce the laser power density of the output beam of radiation.

7. A laser radar device as claimed in claim 6 wherein mean power reducing means periodically intensity modulates the beam produced by the laser source.

8. A laser radar device as claimed in claim 7 wherein the mean power reducing means prevents emission of an output beam of radiation outside a measurement period.

9. A laser radar device as claimed in claim 7 wherein the mean power reducing means intensity modulates the laser output beam by direct control of the laser.

10. A laser radar device as claimed in claim 7 wherein the mean power reducing means comprises an intensity modulator acting on the output of the laser source.

11. A laser radar device as claimed in claim 5, wherein the mean power control means is adapted to alter the focussing of the transmitted beam.

12. A laser radar device as claimed in claim 11 wherein the mean power control means is arranged to defocus the transmitted beam when not making a measurement.

13. A laser radar device according to claim 5, wherein the mean power reducing means comprises a means of applying a spatial dither to the transmitted beam so as to move the point of focus.

14. A laser radar device as claimed in claim 13 wherein the maximum spatial dither applied is greater than or equal to the beam diameter at the point of focus.

15. A laser radar device as claimed in claim 13 wherein the maximum amount of spatial dither applied is less than 20 times the beam diameter at the point of focus, or less than 10 times the beam diameter at the point of focus or less than 5 times the beam diameter at the point of focus.

16. A laser radar device as claimed in claim 13 wherein the mean power reducing means is adapted to apply continuous spatial dither.

17. A laser radar device as claimed in claim 13 wherein the mean power reducing means is adapted to apply periodic spatial dither.

18. A laser radar device as claimed claim 13 wherein the mean power reducing means is adapted to apply spatial dither on a timescale such that the point of focus is dithered at least once in each measurement time.

19. A laser radar device as claimed claim 13 wherein the rate of application of spatial dither is such that the point of focus is varied from a first position to a second non-overlapping position.

20. A laser radar device as claimed in claim 13 wherein the means for applying spatial dither comprises a moveable optical element.

21. A laser radar device as claimed in claim 20 wherein the means for applying spatial dither comprises a rotatable transmissive element.

22. A laser radar device as claimed in claim 20 wherein the means for applying spatial dither comprises a moveable mirror arranged in the optical path to direct the transmitted beam.

23. A laser radar device as claimed in claim 20 wherein the means for applying spatial dither comprises means for moving the fibre optic cable relative to some transmit optical elements.

24. A laser radar device as claimed in claim 1, wherein the radar device is a staring laser radar device or a stepped staring laser radar device.

25. A laser radar device according to claim 1, comprising fibre optic cable for guiding radiation from the source to the device output.
